(19) United States
(12) Patent Application Publication
(10) Pub. No.: US 2021/0026087 A1
(43) Pub. Date: Jan. 28, 2021

(54) Printed Circuit Board Mountable Fiber Optic Transceiver

(71) Applicant: Senko Advanced Components, Inc., Marlborough, MA (US)

(72) Inventor: Paul NEWBURY, Ashland, MA (US)

(73) Assignee: Senko Advanced Components, Inc., Marlborough, MA (US)

(21) Appl. No.: 16/938,320

(22) Filed: Jul. 24, 2020

Related U.S. Application Data
(60) Provisional application No. 62/878,274, filed on Jul. 24, 2019.

(51) Int. Cl. G02B 6/42; G02B 6/38

(52) U.S. Cl. CPC G02B 6/4292; G02B 6/3825; G02B 6/428; G02B 6/4238; G02B 6/3897

(57) ABSTRACT

A fiber optic adapter for connecting to a fiber optic connector includes an adapter housing having an interior. A fiber optic transceiver to be electrically connected to a printed circuit board (PCB) is disposed in the interior of the adapter housing. The fiber optic transceiver is arranged so that optical signals can be communicated between the fiber optic transceiver and the fiber optic connector when the fiber optic connector is attached to the adapter. A retainer is engaged with the fiber optic transceiver to retain the fiber optic transceiver when the fiber optic connector is attached or detached from the adapter.

### CROSS-REFERENCE TO RELATED APPLICATION

This application claims priority to U.S. Provisional App. No. 62/878,274, filed Jul. 24, 2019, the entirety of which is hereby incorporated by reference.

### FIELD

The present disclosure generally relates to fiber optic connections, and, more specifically, to a fiber optic adapter for connecting to a fiber optic connector.

### BACKGROUND

Optical connectors are used within optical communication networks to interconnect optical cables to optical devices, such as optical sub-assemblies. Optical sub-assemblies are used to convert the optical signals of the optical communication network to electrical signals and vice versa. Optical sub-assemblies are typically connected to a printed circuit board (PCB) of an electronic device, thereby providing a communications interface between the electronic device (e.g., the PCB) and the optical communication network. The electronic device can be any device connected to the optical communication network, such as a medical device.

### SUMMARY

In one aspect, a fiber optic adapter for connecting to a fiber optic connector comprises an adapter housing having an interior. A board mountable fiber optic transceiver is configured for electrical connection to a printed circuit board (PCB). The fiber optic transceiver is disposed in the interior of the adapter housing so that optical signals can be communicated between the fiber optic transceiver and the fiber optic connector when the fiber optic connector is attached to the adapter. A retainer is engaged with the fiber optic transceiver to retain the fiber optic transceiver in the adapter housing when the fiber optic connector is attached or detached from the connector coupler.

In another aspect, a fiber optic adapter for connecting to a fiber optic connector comprises an adapter housing having an interior. An optical sub-assembly is disposed in the interior of the adapter housing so that optical signals can communicate between the optical sub-assembly and the fiber optic connector when the fiber optic connector is coupled to the adapter. The optical sub-assembly includes a plurality of pins. An adapter plate at least partially defines the interior. The adapter plate has a plurality of pin openings. Each pin of the optical sub-assembly extends through one of the pin openings. The adapter plate is configured to engage one or more of the pins extending through the pin openings to prevent the optical sub-assembly from rotating relative to the adapter plate.

In another aspect, a fiber optic adapter for connecting to a fiber optic connector and to a printed circuit board (PCB) comprises an adapter housing having an interior. The adapter housing includes at least one PCB connector configured to attach to the PCB for mounting the adapter housing on the PCB. An optical sub-assembly is disposed in the interior of the adapter housing so that optical signals can be communicated between the optical sub-assembly and the fiber optic connector when the fiber optic connector is attached to the adapter.

Other objects and features of the present disclosure will be in part apparent and in part pointed out hereinafter.

### BRIEF DESCRIPTION OF THE DRAWINGS

FIG. 1 is a left side perspective of a fiber optic adapter according to one embodiment of the present disclosure;

FIG. 2 is a right side perspective of the fiber optic adapter;

FIG. 3 is an exploded view of the fiber optic adapter;

FIG. 4 is a section of the fiber optic adapter taken in a plane including line 4-4 in FIG. 1;

FIG. 5 is an enlarged fragment of the section of FIG. 4;

FIG. 6 is a bottom perspective of an adapter housing of the fiber optic adapter;

FIG. 7 is an enlarged, fragmentary, bottom perspective of the fiber optic adapter;

FIG. 8 is a perspective of a fiber optic adapter according to another embodiment of the present disclosure attached to a printed circuit board;

FIG. 9 is a perspective of the fiber optic adapter of FIG. 8 with the adapter housing removed to reveal interior details;

FIG. 10 is a perspective of transmitter and receiver optical sub-assemblies each connected to a fiber optic connector; and

FIG. 11 is a perspective of the transmitter and receiver optical sub-assemblies of FIG. 10, with a housing of the receiver optical sub-assembly removed to reveal interior details.

Corresponding reference characters indicate corresponding parts throughout the drawings.

### DETAILED DESCRIPTION

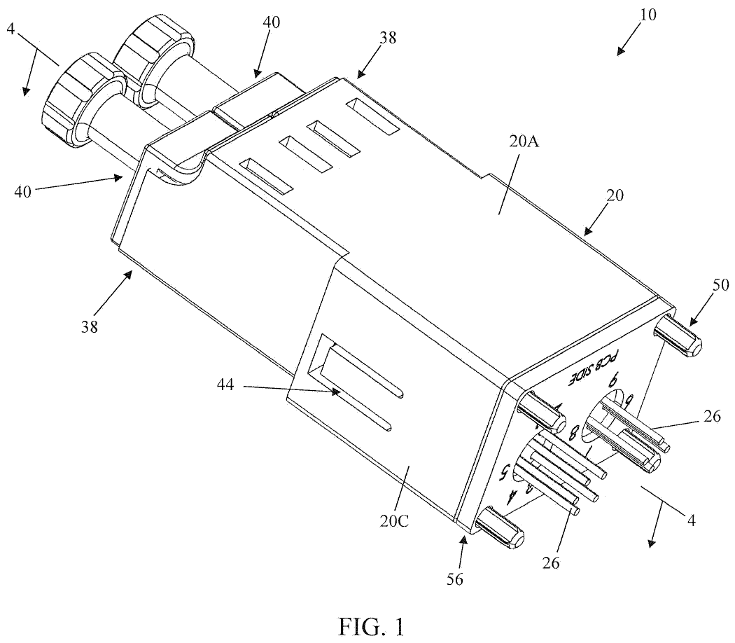

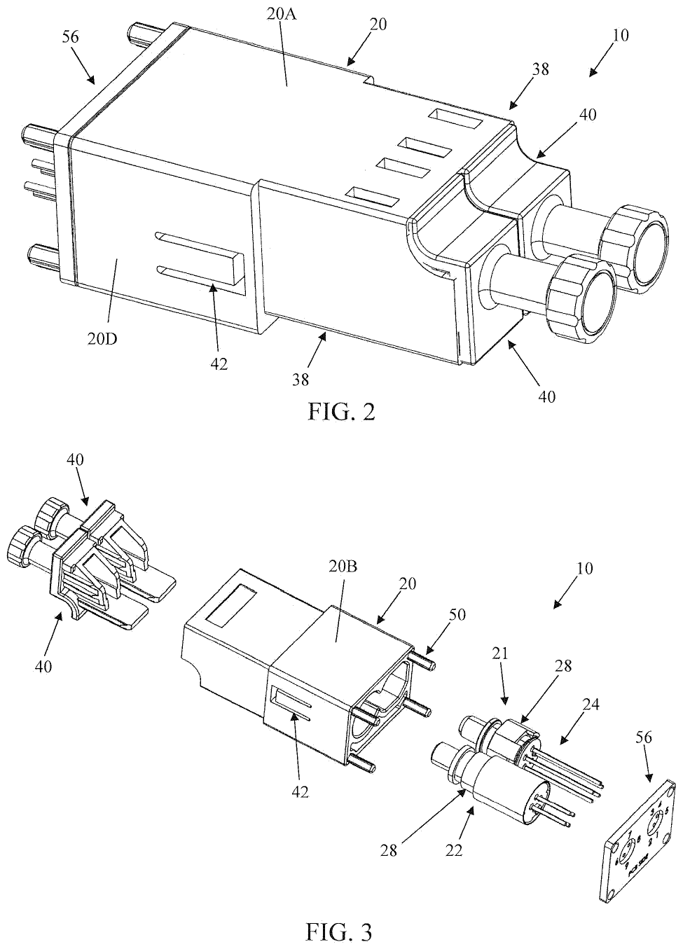

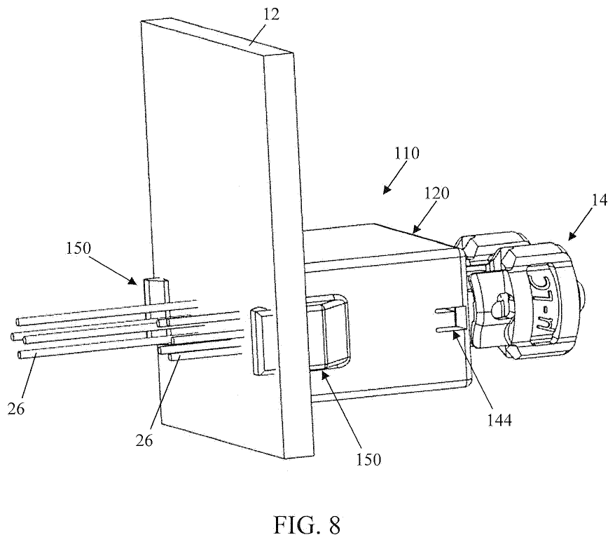

Referring to FIGS. 1 and 2, one embodiment of a fiber optic adapter is generally indicated at reference numeral 10. The fiber optic adapter 10 is an interface used to form a communication connection between an optical communications network and an electronic device. The fiber optic adapter is used to connect optical cables (not shown) of the optical communications network to a printed circuit board (PCB) 12 (FIG. 8) of the electric device. The electric device may be any device that is to be coupled to an optical communications network. The fiber optic adapter 10 converts the optical (e.g., light) signals from the optical cables to electronic signals and vice versa. Accordingly, the fiber optic adapter 10 provides an interface for the PCB 12 to communicate (e.g., send and receive signals) over the optical communications network.

Referring to FIGS. 3-5, the fiber optic adapter 10 includes aboard mountable fiber optic transceiver 21 configured for electrical connection to the PCB 12. The fiber optic transceiver 21 is configured to send and receive optical signals over one or more optical cables and to send and receive electrical signals to and from, respectively, the PCB 12, the electrical signals corresponding to the optical signals and vice versa. In the illustrated embodiment, the fiber optic transceiver 21 includes a first optical sub-assembly 22 and a second optical sub-assembly 24 (broadly, at least one optical sub-assembly). In other embodiments, the fiber optic adapter 10 (e.g., fiber optic transceiver 21) may include more or fewer optical sub-assemblies. The optical sub-assembly 22, 24 may be a transmitter optical sub-assembly (TOSA), a receiver optical sub-assembly (ROSA), or a bi-directional optical sub-assembly (BOSA). As generally known in the art, a transmitter optical sub-assembly coverts electrical signals to optical signals, a receiver optical sub-assembly coverts optical signals to electrical signals and a bi-directional optical sub-assembly can do both, covert optical signals to electrical signals and vice versa. In the illustrated embodiment, the first optical sub-assembly 22 is a transmitter optical sub-assembly and the second optical sub-assembly 24 is a receiver optical sub-assembly, although other configurations are within the scope of the present disclosure.

The fiber optic transceiver 21 includes a plurality of electrical pins 26 configured to be coupled (e.g., soldered) to the PCB 12. Each optical sub-assembly 22, 24 includes a subset of the pins 26 (e.g., each optical sub-assembly 22, 24 includes a plurality of pins). The pins 26 are configured to be communicatively coupled to the PCB 12 and communicate (e.g., transfer) the electronic signals between the PCB and the fiber optic transceiver 21 (i.e., the optical sub-assemblies 22, 24). The pins 26 may also perform other functions such as grounding and carrying power. In one embodiment, the pins 26 extend through designated electrical openings (not shown) in the PCB 12 and are soldered to the PCB. Each optical sub-assembly 22, 24 includes a housing 28. In FIG. 11, the housing 28 of the receiver optical sub-assembly 24 is hidden from view to show the photodiode 25 of the sub-assembly within the housing which receives the optical signal from a ferrule 15 of a fiber optic connector 14 of the optical cable and converts the optical signal to a corresponding electrical signal. In conventional arrangements, fiber optic connectors 14 (FIG. 8) of the optical cables connect directly to the housing of the optical sub-assembly (broadly, “to the fiber optic transceiver 21”) and the optical sub-assembly relies on the solder connection between the pins 26 and the PCB to secure the optical sub-assembly to the PCB. However, in this arrangement, the solder can easily break when the fiber optic connectors 14 are connected to or disconnected from the optical sub-assembly (due to the pushing or pulling forces), damaging the electrical connection between the PCB and the fiber optic transceiver and possibly preventing the exchange of electrical signals between the PCB and the fiber optic transceiver.

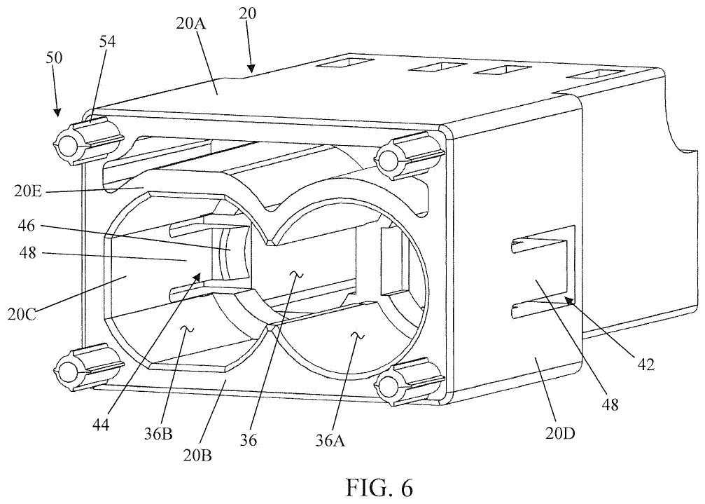

Referring to FIGS. 1-7, the fiber optic adapter 10 includes an adapter housing 20. The adapter housing 20 has an interior 36 (FIG. 6). The interior 36 is sized and shaped to receive and hold the fiber optic transceiver 21, specifically the optical sub-assemblies 22, 24. In the illustrated embodiment, the interior 36 includes a first interior section 36A sized and shaped to receive and hold the transmitter optical sub-assembly 22 and a second interior section 36B sized and shaped to receive and hold the receiver optical sub-assembly 24. The size and shapes of the interior sections 36A, 36B correspond to the size and shape of the respective transmitter and receiver optical sub-assemblies 22, 24 (e.g., housings 28). As shown, the fiber optic transceiver 21 (i.e., the transmitter and receiver optical sub-assemblies 22, 24) is disposed in the interior 36 of the adapter housing 20 (e.g., the first and second interior sections 36B, 36A). The interior 36 has opposite open proximal and distal ends. The adapter housing 20 includes opposite front and rear walls 20A, 20B and opposite left and right side walls 20C, 20D. The front, rear, left side and right side walls 20A-D define the interior 36. The adapter housing 20 may also include an intermediate wall 20E disposed in the interior 36 and further dividing the interior (e.g., first and second interior sections 36A, 36B).

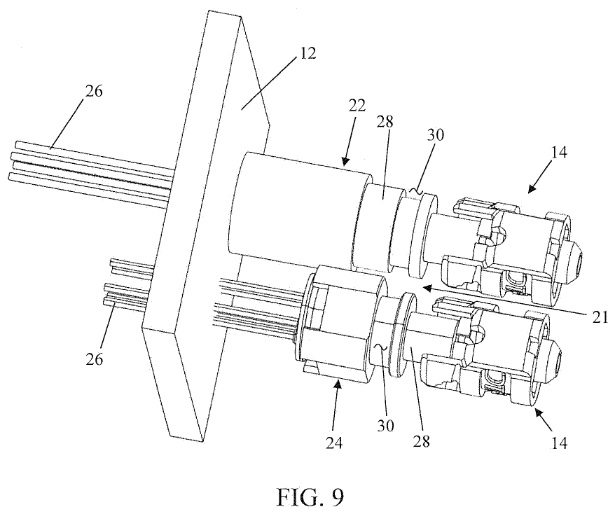

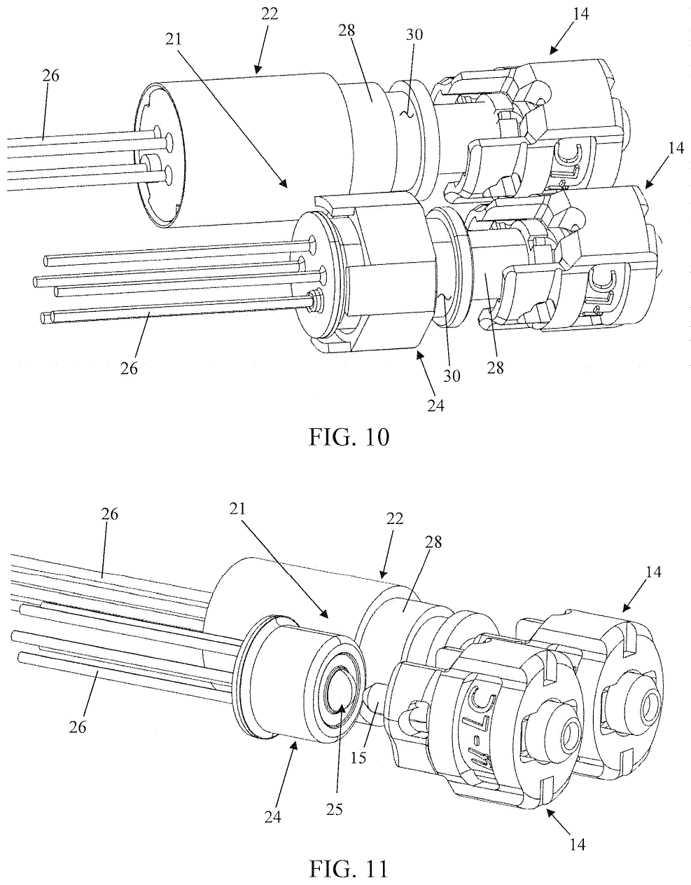

The fiber optic adapter 10 is configured to connect to a fiber optic connector 14 (broadly, at least one fiber optic connector). The adapter housing 20 includes a connector coupler 38 (broadly, at least one connector coupler) configured to releasably attach a fiber optic connector 14 to the adapter housing. The connector coupler 38 is disposed at the distal end of the adapter housing 20. The connector coupler 38 is arranged (e.g., aligned) with respect to the fiber optic transceiver 21 so that optical signals can be communicated (e.g., transmitted) between the fiber optic transceiver and the fiber optic connector 14 when the fiber optic connector is attached to the connector coupler. In the illustrated embodiment, the adapter housing 20 includes two (e.g., first and second) connector couplers 38. Each connector coupler 38 is associated with one of the optical sub-assemblies 22, 24. Each optical sub-assembly 22, 24 is arranged with respect to one of the connector couplers 38 so that optical signals can be communicated between the optical sub-assembly and the fiber optic connector 14 when the fiber optic connector is coupled to the connector coupler. In the illustrated embodiment, the connector coupler 38 is a female connector coupler defining a space sized and shaped to receive the fiber optic connector 14. The connector coupler 38 may be any suitable connector coupler such as, but not limited to, a LC connector coupler (to connect to LC fiber optic connectors), a SC connector coupler (to connect to SC fiber optic connectors), a ST connector coupler (to connect to ST fiber optic connectors), etc. In the illustrated embodiment, the connector couplers 38 are LC connector couplers. It is understood that the fiber optic connectors 14 shown in FIGS. 8-11 are used as examples to facilitate understanding of the present disclosure and that these fiber optic connectors are not compatible with (e.g., not configured to connect to) the connector couplers 38 shown in FIGS. 1-5. In the illustrated embodiment, the adapter housing 20 includes caps 40 coupled to the connector couplers 38. The caps 40 protect the optical sub-assemblies and inhibit particles (e.g., dust) from collecting in the connector couplers 38 and/or interior 36. The caps 40 are removed from the connector couplers 38 prior to the connection of the fiber optic connectors 14.

The fiber optic adapter 10 includes at least one retainer configured to retain the fiber optic transceiver 21 in the adapter housing 20. The retainer engages the fiber optic transceiver 21 to retain the transceiver when the fiber optic connector 14 is attached or detached from the connector coupler 38. In the illustrated embodiment, the fiber optic adapter 10 includes two (e.g., first and second) retainers 42, 44. Each retainer 42, 44 retains one of the optical sub-assemblies 22, 24 of the fiber optic transceiver 21. Each retainer 42, 44 engages with one of the optical sub-assemblies 22, 24 to retain said optical sub-assembly. The first retainer 42 retains the transmitter optical sub-assembly 22 and the second retainer 44 retains the receiver optical sub-assembly 24. The retainers 42, 44 retain (e.g., inhibit movement of) the optical sub-assemblies 42, 44 when the fiber optic connectors 14 are attached and/or detached from the connector couplers 38. Fiber optic connectors 14 generally engage their corresponding optical sub-assembly 42, 44 when coupled therewith. Accordingly, as mentioned above, coupling and decoupling a fiber optic connector 14 to an optical sub-assembly 22, 24 subjects the optical sub-assembly to forces which may urge the optical sub-assembly to move and damage (e.g., break) the connection between the optical sub-assembly 22, 24 and the PCB 12. The retainers 42, 44 retain (e.g., brace, restrain) the fiber optic transceiver 21 (i.e., optical sub-assemblies 22, 24) to inhibit or prevent the fiber optic transceiver from moving when the fiber optic connector 14 is attached or detached to maintain the integrity of the connection between the fiber optic transceiver and the PCB 12. In the illustrated embodiment, the retainers 42, 44 may also secure the fiber optic transceiver 21 (e.g., optical sub-assemblies 22, 24) to the adapter housing 20. In other words, the retainers 42, 44 hold the fiber optic transceiver 21 (e.g., optical sub-assemblies 22, 24) in place in the interior 36 of the adapter housing 20.

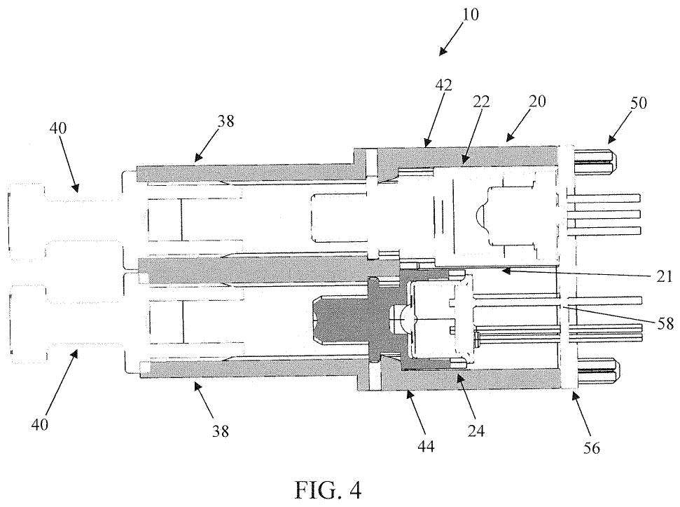

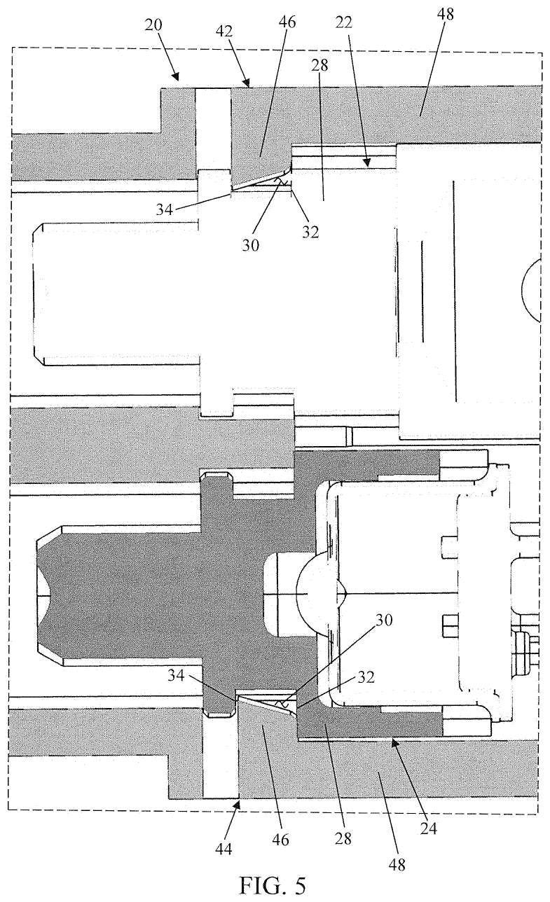

Referring to FIGS. 4 and 5, the retainers 42, 44 are generally identical (e.g., are mirror images of one another). Each retainer 42, 44 includes a detent 46 engaged with the fiber optic transceiver 21 to retainer the fiber optic transceiver. The detent 46 of the first retainer 42 is engaged with the transmitter optical sub-assembly 22 and the detent of the second retainer 44 is engaged with the receiver optical sub-assembly 24. The fiber optic transceiver 21 includes a channel or recess 30 and opposite proximal and distal (e.g., first and second) shoulders (e.g., side surfaces) 32, 34 defining the recess. In the illustrated embodiment, each housing 28 of the optical sub-assemblies 22, 24 includes the recess 30 and the proximal and distal shoulders 32, 34. The recess 30 and proximal and distal shoulders 32, 34 extend circumferentially around the housing 28. The detent 46 of each retainer 42, 44 is disposed in the recess 30 of the corresponding optical sub-assembly 22, 24 to retain the optical sub-assembly (broadly, the fiber optic transceiver 21). The detent 46 engages at least one of the proximal or distal shoulders 32, 34 of the fiber optic transceiver 21 to prevent the fiber optic transceiver from moving in at least one direction (e.g., a proximal and/or distal direction). In the illustrated embodiment, the detent 46 of the first retainer 42 engages the distal shoulder 34 of the transmitter optical sub-assembly 22 to prevent the transmitter optical sub-assembly from moving in a proximal or first direction. In this embodiment, the housing 28 (e.g., a flange including the distal shoulder 34) of the transmitter optical sub-assembly 22 engages the adapter housing 20 to prevent the transmitter optical sub-assembly from moving in a distal or second direction. The detent 46 of the second retainer 44 engages the distal shoulder 34 of the receiver optical sub-assembly 24 to prevent the receiver optical sub-assembly from moving in the proximal direction. The detent 46 of the second retainer 44 also engages the proximal shoulder 32 of the receiver optical sub-assembly 24 to prevent the receiver optical sub-assembly (broadly, the fiber optic transceiver 21) from moving in a distal or second direction. The proximal and distal directions are generally opposite one another.

The retainers 42, 44 are configured to form a snap-fit connection with the fiber optic transceiver 21. Specifically, each retainer 42, 44 is configured to form a snap-fit connection with one of the optical sub-assemblies 22, 24. Each retainer 42, 44 includes a leg 48 secured to the adapter housing 20. The detent 46 of each retainer 42, 44 extends from the leg 48 (e.g., a distal end thereof) into the interior 36 of the adapter housing 20. The leg 48 is resiliently deflectable. As the fiber optic transceiver 21 (e.g., the optical sub-assemblies 22, 24) is inserted into the interior 36 of the adapter housing 20, the fiber optic transceiver 21 deflects the retainers 42, 44 (e.g., legs 48) outward until the recesses 30 are aligned with the detents 46. Once aligned, the retainers 42, 44 return or snap back inward, toward their at rest position (FIG. 5), moving the detents 46 inward into the recesses 30, thereby retaining the fiber optic transceiver 21. The deflection is facilitated by an inwardly facing ramp surface on the detent 46. In the illustrated embodiment, each retainer 42, 44 (e.g., leg 48) is integrally formed with the adapter housing 20 (e.g., the retainers and adapter housing are formed as a single piece). Other configurations of the retainers are within the scope of the present disclosure.

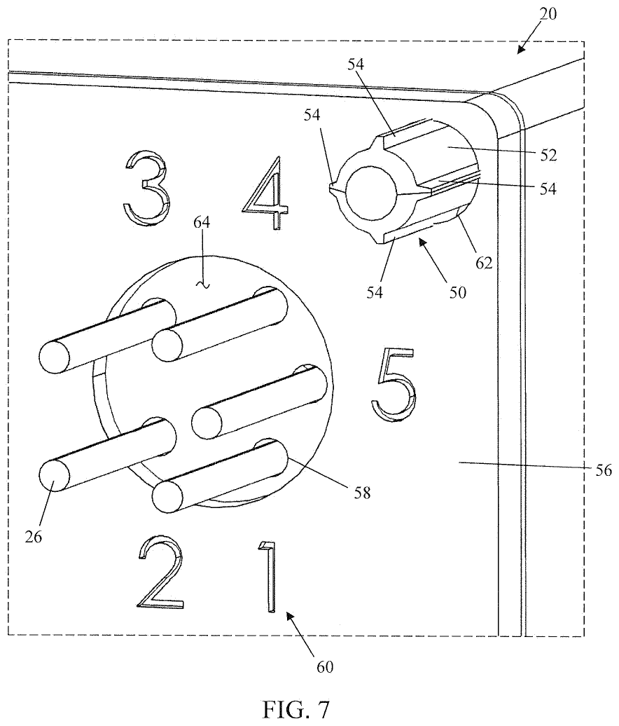

Referring to FIGS. 6 and 7, the fiber optic adapter 10 is configured to connect to the PCB 12. Specifically, the adapter housing 20 is configured to attach to (e.g., mount on) the PCB 12. The adapter housing 20 includes at least one PCB connector 50 configured to form a connection with the PCB 12. In the illustrated embodiment, the PCB connector 50 forms an interference (e.g., a friction) fit with the PCB 12 to secure the fiber optic adapter 10 to the PCB. In the illustrated embodiment, the adapter housing 20 includes four PCB connectors 50, although more or fewer PCB connectors are within the scope of the present disclosure. The PCB connectors 50 are disposed at the proximal end of the adapter housing 20. Each PCB connector 50 extends proximally from the walls 20A-D of the adaptor housing 20. In the illustrated embodiment, the PCB connectors 50 are arranged at the corners of the adapter housing 20 (e.g., corners formed by walls 20A-D), although other arrangements are within the scope of the present disclosure.

Each PCB connector 50 includes a projection or leg 52. The leg 52 is generally cylindrical (e.g., has a circular cross-sectional shape). The leg 52 is sized and shaped to be inserted into (and possibly through) a corresponding adapter opening (not shown) of the PCB 12. Each PCB connector 50 is inserted into one adapter opening of the PCB 12. Accordingly, the arrangement of the PCB connectors 50 corresponds to the arrangement of the adapter openings on the PCB 12. Each PCB connector 50 may also include at least one rib 54 on the leg 52. In the illustrated embodiment, each PCB connector 50 includes four ribs 54, although more or fewer ribs are within the scope of the present disclosure. Each rib 54 extends outward from the leg 52. In addition, each rib 54 extends along substantially the entire length of the leg 52. The ribs 54 are configured to engage the PCB 12 within the adapter openings to secure the fiber optic adapter 10 to the PCB. The ribs 54 have a height (extending outward from the leg 52) large enough such that the outer diameter (measured to the free end or edge of the ribs) of the PCB connector 50 is larger than the diameter of the adapter opening in the PCB 12, thereby ensuring the PCB connector engages the PCB. Each rib 54 may be configured to deform when engaged by the PCB 12 to form the interference fit and/or deform the PCB to form the interference fit. Other configurations of the PCB connector are within the scope of the present disclosure.

Referring to FIGS. 1-4 and 7, the fiber optic adapter 10 includes an adapter plate 56. The adapter plate 56 is generally deposed on the proximal end of the adapter housing 20 and may be considered part of the adapter housing. The adapter plate 56 has opposite proximal and distal surfaces. The proximal surface of the adapter plate 56 can engage the PCB 12 when the fiber optic adapter 10 is attached to the PCB. The adapter plate 56 at least partially defines the interior 36. The adapter plate 56 closes the open proximal end of the interior 36, further securing the fiber optic transceiver 21 (e.g., optical sub-assemblies 22, 24) in the adapter housing 20. The adapter plate 56 is generally planar. The pins 26 of the fiber optic transceiver 21 extend through the adapter plate 56. The adapter plate 56 has a plurality of pin openings 58. The pin openings 58 are generally aligned with the pins 26 and each pin opening is sized and shaped to receive one of the pins. Each pin 26 extends through (e.g., is disposed in) one of the pin openings 58. The adapter plate 56 is configured to engage the fiber optic transceiver 21 to prevent the movement of the fiber optic transceiver relative to the adapter housing 20. Specifically, the adapter plate 56 is configured to engage one or more of the pins 26 extending through the pin openings 58 to prevent at least one of the optical sub-assemblies 22, 24 from rotating relative to the adapter plate. For example, the transmitter optical sub-assembly 22 has a generally circular cross-sectional shape that can rotate within the adapter housing 20, unless inhibited by the adapter plate 56. The adapter plate 56 includes indicia 60 thereon for identifying the pins 26 (and the pin openings 58) of the fiber optic transceiver 21. In the illustrated embodiment, the indicia 60 is numbering (e.g., numbers 1-9), although other types of indicia (e.g., letters) are within the scope of the present disclosure. The indicia 60 is used to identify each pin 26 in order to properly connect (e.g., electrically connect) the fiber optic transceiver 21 to the PCB 12. By inhibiting movement (e.g., rotation) of the transmitter optical sub-assembly 22, the adapter plate 56 keeps the pins 26 in their correct positions and, thus, correctly identified by the indicia 60.

The adapter plate 56 is rigidly coupled to the adapter housing 20. Accordingly, the adapter plate 56 prevents the optical sub-assemblies 22, 24 from rotating relative to the adapter housing 20. In the illustrated embodiment, the adapter plate 56 is attached to the adapter housing 20 with the PCB connectors 50. Each PCB connector 50 is configured to form a connection with the adapter plate 56. Each PCB connector 50 forms an interference with the adapter plate 56 to connect the adapter plate to the adapter housing 20. The adapter plate 56 includes adapter housing openings 62. Each adapter housing opening 62 is sized and shaped to receive a corresponding PCB connector 50 therethrough. Thus, the arrangement of adapter housing openings 62 on the adapter plate 56 corresponds to the arrangement of the PCB connectors 50. The ribs 54 of the PCB connectors 50 are configured to engage the adapter plate 56 within the adapter housing openings 62 (e.g., the edges or surfaces of the adapter plate defining the adapter housing openings) to secure the adapter plate to the adapter housing 20. The outer diameter of the PCB connector 50 is larger than the diameter of the adapter housing opening 62 (similar to the adapter opening in the PCB 12), thereby ensuring the PCB connector engages the adapter plate. Each rib 54 may be configured to deform when engaged by the adapter plate 56 to form the interference fit and/or deform the adapter plate to form the interference fit. In one embodiment, the openings 62 in the adapter housing are sized somewhat larger than the openings in the PCB 12 that receive the legs 50. In this way, the ribs 54 are still able to make a good interference fit with the PCB 12 even if deformed somewhat by their engagement with the adapter housing openings 62 in the adapter plate 56.

At least a portion of the adapter plate 56 adjacent the pin openings 58 is configured with respect to the adapter housing 20 to be spaced apart from the PCB 12 when the adapter housing is connected to the PCB (e.g., when the adapter plate engages the PCB). This reduces the likelihood the adapter plate 56 being damaged (e.g., melting) when the pins 26 are soldered to the PCB 12. In the illustrated embodiment, the adapter plate 56 includes a recess 64 arranged with respect to each set of pin openings 58 for the pins 26 of the optical sub-assemblies 22, 24. The recesses 64 extend distally from the proximal surface of the adapter plate 56. The recess 64 spaces the portion of the adapter plate 56 adjacent the pins 26 away from the PCB 12 to minimize the effect of any heat on the adapter plate from the soldering. In one embodiment, the adapter plate 56 is made of material that resists heat transfer from the pins 26 to the adapter housing 20.

Referring to FIGS. 8-11, another embodiment of the fiber optic adapter according to the present disclosure is generally indicated by reference numeral 110. Fiber optic adapter 110 is generally analogous to and includes some identical components to that of fiber optic adapter 10. Thus, for ease of comprehension, where similar or analogous parts are used, reference numerals “100” units higher are employed and where identical parts are used, identical reference numerals are employed. Accordingly, unless clearly stated or indicated otherwise, the above descriptions regarding fiber optic adapter 10 also apply to fiber optic adapter 110.

In this embodiment, the fiber optic adapter 110 does not include connector couplers for attaching fiber optic connectors. Instead, in this embodiment, the fiber optic connectors 14 couple directly do the fiber optic transceiver 21 (e.g., the optical sub-assemblies 22, 24), similar to the conventional arrangements described above. The fiber optic transceiver 21 extends through the distal end (e.g., a distal wall (not shown)) of the adapter housing 120. In other words, each optical sub-assembly 22, 24 extends through the adapter housing 120 such that a portion (e.g., a proximal portion) of the optical sub-assembly is disposed in the interior of the adapter housing 120 and a portion (e.g., a distal portion) of the optical sub-assembly is disposed outside the adapter housing. The fiber optic connectors 14 attach to the portions of the housing 28 of the optical sub-assemblies 22, 24 disposed outside the adapter housing 20. In addition, in this embodiment, the PCB connectors 150 are resiliently deflectable clips configured to clip onto the PCB 12 to secure the fiber optic adapter 110 to the PCB. The clips 150 extend through slots in the PCB 12 and include detents that engage the backside of the PCB 12 to secure the fiber optic adapter 110 to the PCB. In this embodiment, the fiber optic adapter 110 may or may not include the adapter plate. Otherwise, the fiber optic adapter 110 is generally the same as fiber optic adapter 10. For example, fiber optic adapter 110 includes first and second retainers to retain the respective optical sub-assemblies 22, 24 (only the second retainer 144 is visible in the figures).

Modifications and variations of the disclosed embodiments are possible without departing from the scope of the invention defined in the appended claims. For example, where specific dimensions are given, it will be understood that they arc exemplary only and other dimensions are possible.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A fiber optic adapter for connecting to a fiber optic connector, the fiber optic adapter comprising:
an adapter housing having an interior;
a board mountable fiber optic transceiver configured for electrical connection to a printed circuit board (PCB), the fiber optic transceiver being disposed in the interior of the adapter housing and arranged so that optical signals can be communicated between the fiber optic transceiver and the fiber optic connector when the fiber optic connector is attached to the adapter; and
a retainer engaged with the fiber optic transceiver to retain the fiber optic transceiver when the fiber optic connector is attached or detached from the adapter.

2. The fiber optic adapter of claim 1, wherein the retainer secures the fiber optic transceiver to the adapter housing.

3. The fiber optic adapter of claim 1, wherein the retainer forms a snap-fit connection with the fiber optic transceiver.

4. The fiber optic adapter of claim 1, wherein the retainer includes a detent engaged with the fiber optic transceiver to retain the fiber optic transceiver.

5. The fiber optic adapter of claim 4, wherein the fiber optic transceiver comprises a recess and a shoulder, the detent being disposed in the recess and engaging a first shoulder of the fiber optic transceiver to prevent the fiber optic transceiver from moving in a first direction.

6. The fiber optic adapter of claim 5, wherein the fiber optic transceiver further comprises a second shoulder, the detent engaging the second shoulder of the fiber optic transceiver to prevent the fiber optic transceiver from moving in a second direction generally opposite the first direction.

7. The fiber optic adapter of claim 1, wherein the retainer is integrally formed with the adapter housing.

8. The fiber optic adapter of claim 1, wherein the retainer is a first retainer, the adapter housing including a second retainer, and the fiber optic transceiver includes a transmitter optical sub-assembly and a receiver optical sub-assembly, the transmitter optical sub-assembly being disposed in the interior of the adapter housing, engaged by the first retainer to retain the transmitter optical sub-assembly and aligned so that an optical signal can be transmitted from the transmitter optical sub-assembly to the first fiber optic connector when attached to the adapter, and the receiver optical sub-assembly being disposed in the interior of the adapter housing, engaged by the second retainer to retain the receiver optical sub-assembly and aligned so that an optical signal can be received by the receiving optical sub-assembly from the second fiber optic connector when attached to the adapter.

9. The fiber optic adapter of claim 1, wherein the adapter housing is configured to mount on the PCB.

10. The fiber optic adapter of claim 10, wherein the adapter housing includes at least one PCB connector configured to form an interference fit with the PCB to mount the adapter housing to the PCB.

11. The fiber optic adapter of claim 1, further comprising an adapter plate configured to engage the fiber optic transceiver to prevent the movement of the fiber optic transceiver relative to the adapter housing.

12. The fiber optic adapter of claim 1 wherein the fiber optic transceiver comprises a plurality of electrical pins configured to be soldered to the PCB.

13. A fiber optic adapter for connecting to a fiber optic connector, the fiber optic adapter comprising:
an adapter housing having an interior;
an optical sub-assembly disposed in the interior of the adapter housing and aligned so that optical signals can communicate between the optical sub-assembly and the fiber optic connector when the fiber optic connector is coupled to the adapter, the optical sub-assembly including a plurality of pins; and
an adapter plate at least partially defining the interior, the adapter plate having a plurality of pin openings, each pin of the optical sub-assembly extends through one of the pin openings, wherein the adapter plate is configured to engage one or more of the pins extending through the pin openings to prevent the optical sub-assembly from rotating relative to the adapter plate.

14. The fiber optic adapter of claim 13, wherein the adapter plate is rigidly coupled to the adapter housing such that the adapter plate prevents the optical sub-assembly from rotating relative to the adapter housing.

15. The fiber optic adapter of claim 14, wherein at least a portion of the adapter plate adjacent the pin openings is configured with respect to the adapter housing to be spaced apart from the PCB when the adapter housing is connected to the PCB.

16. The fiber optic adapter of claim 13 wherein the adapter plate has indicia thereon for identifying the pins of the optical sub-assembly extending through the plate.

17. A fiber optic adapter for connecting to a fiber optic connector and to a printed circuit board (PCB), the fiber optic adapter comprising:
an adapter housing having an interior, the adapter housing including at least one PCB connector configured to attach to the PCB for mounting the adapter housing on the PCB; and
an optical sub-assembly disposed in the interior of the adapter housing and aligned so that optical signals can be communicated between the optical sub-assembly and the fiber optic connector when the fiber optic connector is attached to the adapter.

18. The fiber optic adapter of claim 17, wherein the PCB connector is configured to form an interference fit with the PCB.

19. The fiber optic adapter of claim 18, wherein the PCB connector comprises a leg configured to extend into an opening of the PCB.

20. The fiber optic adapter of claim 19, wherein the PCB connector comprises at least one rib on the leg, the at least one rib configured to engage the PCB within the opening to secure the adapter housing to the PCB.
